(19) United States
(12) Patent Application Publication
(10) Pub. No.: US 2019/0205108 A1
(43) Pub. Date: Jul. 4, 2019

(54) SYSTEM AND METHOD FOR PROVIDING SOFTWARE APPLICATIONS

(71) Applicant: Cognant LLC, Mountain View, CA (US)

(72) Inventors: Ethan Anderson, Mountain View, CA (US); Yonatan Ellert, Sunnyvale, CA (US); Ali Sener, Palo Alto, CA (US); Susanna Orr, Palo Alto, CA (US)

(21) Appl. No.: 16/204,113

(22) Filed: Nov. 29, 2018

Related U.S. Application Data
(60) Provisional application No. 62/611,789, filed on Dec. 29, 2017.

(51) Int. Cl. G06F 8/61; G06F 8/71; G06F 21/12; A63F 13/49

(52) U.S. Cl. CPC G06F 8/61; A63F 13/49; G06F 21/121; G06F 8/71

(57) ABSTRACT

Implementations of the present disclosure are directed to a method, a system, and an article for providing software on client devices. An example computer-implemented method can include: providing, for each of a plurality of online games, access to (i) a client application configured to provide a full version of the online game and (ii) a server application configured to provide a trial version of the online game; receiving a request from a user client device to play the trial version of a selected online game and, in response thereto: running the trial version of the selected online game on a server computer; enabling a user to interact with the trial version on the user client device; receiving a request from the user to download the full version of the selected online game; and providing the client application for the selected online game to the user client device.

### CROSS-REFERENCE TO RELATED APPLICATIONS

This application claims the benefit of U.S. Provisional Patent Application No. 62/611,789, filed Dec. 29, 2017, the entire contents of which are incorporated by reference herein.

### BACKGROUND

The present disclosure relates to providing software applications and, in certain examples, to systems and methods for providing trial versions and full versions of software applications for online games.

Software application markets are generally configured to allow users to search for and download software applications or mobile apps. These markets can display information about each available app to help users decide whether or not to purchase and/or download the app. Such information can include the name of the app, an app icon, screenshots, videos, reviews, or a brief description of the app. These markets, however, do not allow the users to play or otherwise interact with the app before it is downloaded.

For example, when a user searches within an app marketplace for, for example, “football games,” the user may be presented with a large number of potentially relevant apps to choose from, as well as a way to view standalone landing pages that give additional information describing each app. Although the landing pages may have static images, descriptions, or even videos, the user is unable to experience real gameplay without downloading the app. Consequently, if the user wants to test multiple games to see which one the user enjoys playing the most, the user may need to download multiple apps from the app marketplace, and then try the full version of each app individually. If the user wants to try three different football games, the user may be able to play each football game only after having downloaded and installed all three games. While some apps may be free, in many cases they are not, so the user may be required to purchase one or more of the apps (for varying amounts of money) to find the one that the user prefers.

The foregoing discussion, including the description of motivations for some embodiments of the invention, is intended to assist the reader in understanding the present disclosure, is not admitted to be prior art, and does not in any way limit the scope of any of the claims.

### SUMMARY

In general, the subject matter described herein relates to providing users with trial versions and full versions of software applications, such as mobile apps for online games. Systems and methods are described that provide a website or other online service through which users can access the trial versions and the full versions. In a typical example involving a plurality of available online games, the website provides access to a client application configured to provide a full version of an online game and a server application configured to provide a trial version of the online game. A graphical user interface for the website allows the user to select either the full version or the trial version from the user's client device. When the user selects the trial version, the trial version can be executed or run on at least one server computer, and the user can interact with the trial version on the client device. If the user is satisfied with the trial version, the user can then use the graphical user interface to select the full version. The client application for the full version is then downloaded to the client device and installed. The user can experience the full version by running the client application on the client device.

Advantageously, the systems and methods described herein can allow users to try new software applications without having to first download and install the applications on user client devices. The trial versions can be run on a server computer without requiring any portion of the application to be downloaded and installed on client devices. This can avoid the time and expense associated with downloading and installing certain applications. If the user is satisfied with the trial version, the user can proceed to install the full version. Otherwise, the user can choose to not download the full version and can search for and try other applications that may be more satisfying, with no downloading required. In general, by allowing users to try software applications without downloading, users can experience less friction and can test or try the applications more quickly and easily. In addition, by avoiding the download, users can save data or space on client devices and/or can avoid having to pay for downloads that the users may or may not want or use. The trial versions can be provided to users free of charge and can allow users to try an app before committing to a purchase and/or download.

Further, the systems and methods can significantly reduce network traffic and/or network hops associated with trying new software applications. Given that users do not need to download an application before trying it, network traffic and data required for the download can be avoided. By running the trial version on the server, the application can be tried immediately, without having to wait for lengthy downloads and installs. The procedure can be made even faster by pre-caching the trial version on the server before it is selected by the user.

Additionally or alternatively, the approach described herein can reduce processing loads on client devices, given that trial versions can be run on the server rather than on the client devices. This can improve client device performance and allow users to try numerous trial versions (e.g., in rapid succession), without overburdening the client device processing capabilities. This performance improvement can be particularly noticeable for large or complex online games, which can require significant data processing and/or storage capabilities.

In one aspect, the subject matter described in this specification relates to a method. The method includes: providing, for each of a plurality of online games, access to (i) a client application configured to provide a full version of the online game and (ii) a server application configured to provide a trial version of the online game; receiving a request from a user client device to play the trial version of a selected online game from the plurality of online games and, in response thereto: running the trial version of the selected online game on at least one server computer; enabling a user to interact with the trial version on the user client device; receiving a request from the user client device to download the full version of the selected online game; and providing the client application for the selected online game to the user client device.

In certain examples, providing access to the client application and the server application can include providing a graphical user interface having an icon for each of the plurality of online games, wherein the icon includes a first button corresponding to the full version and a second button corresponding to the trial version. For each of the plurality of online games, (i) the client application can be configured to be run on user client devices and (ii) the server application can be configured to be run on the at least one server computer. The trial version of the selected online game can lack one or more game features present in the full version of the selected online game. For each of the plurality of online games, the trial version can include a time-limited version of the full version.

In some implementations, running the trial version on the at least one server can include not running the trial version on the user client device. Enabling the user to interact with the trial version can include saving progress of the user in the trial version of the selected online game. Providing the client application for the selected online game can include providing the user with access to the saved progress from the trial version of the selected online game. Providing the client application for the selected online game can include providing a downloadable copy of the client application to the user client device. Providing the client application for the selected online game can include running an installation of the downloadable copy on the user client device.

In another aspect, the subject matter described in this specification relates to a system. The system includes one or more computer processors programmed to perform operations including: providing, for each of a plurality of online games, access to (i) a client application configured to provide a full version of the online game and (ii) a server application configured to provide a trial version of the online game; receiving a request from a user client device to play the trial version of a selected online game from the plurality of online games and, in response thereto: running the trial version of the selected online game on at least one server computer; enabling a user to interact with the trial version on the user client device; receiving a request from the user client device to download the full version of the selected online game; and providing the client application for the selected online game to the user client device.

In some instances, providing access to the client application and the server application can include providing a graphical user interface having an icon for each of the plurality of online games, wherein the icon includes a first button corresponding to the full version and a second button corresponding to the trial version. For each of the plurality of online games, (i) the client application can be configured to be run on user client devices and (ii) the server application can be configured to be run on the at least one server computer. The trial version of the selected online game can lack one or more game features present in the full version of the selected online game. For each of the plurality of online games, the trial version can include a time-limited version of the full version.

In various examples, running the trial version on the at least one server can include not running the trial version on the user client device. Enabling the user to interact with the trial version can include saving progress of the user in the trial version of the selected online game. Providing the client application for the selected online game can include providing the user with access to the saved progress from the trial version of the selected online game. Providing the client application for the selected online game can include providing a downloadable copy of the client application to the user client device. Providing the client application for the selected online game can include running an installation of the downloadable copy on the user client device.

In another aspect, the subject matter described in this specification relates to an article. The article includes a non-transitory computer-readable medium having instructions stored thereon that, when executed by one or more computer processors, cause the computer processors to perform operations including: providing, for each of a plurality of online games, access to (i) a client application configured to provide a full version of the online game and (ii) a server application configured to provide a trial version of the online game; receiving a request from a user client device to play the trial version of a selected online game from the plurality of online games and, in response thereto: running the trial version of the selected online game on at least one server computer; enabling a user to interact with the trial version on the user client device; receiving a request from the user client device to download the full version of the selected online game; and providing the client application for the selected online game to the user client device.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims

### DESCRIPTION OF THE DRAWINGS

FIG. 1 is a schematic diagram of an example system for providing trial versions and full versions of software applications on user client devices.

FIG. 2 is a schematic diagram of an example method of providing trial versions of software applications on user client devices.

FIG. 3 is a schematic diagram of an example method of providing full versions of software applications on user client devices.

FIG. 4 is a schematic diagram of an example landing page for a software application that can be accessed as a trial version and a full version.

FIG. 5 is a flowchart of an example method of providing trial versions and full versions of software applications on user client devices.

### DETAILED DESCRIPTION

In general, the systems and methods described herein can provide trial versions of software applications (also referred to herein as “apps”) that allow users to try the software applications without having to first download and install the software applications on user client devices (e.g., mobile devices). For example, a user can access and experience a trial version of a software application to decide whether or not the user is satisfied with the software application, before downloading and installing a full version of the software application. The trial version can be run on a server computer without requiring any portion of the trial version to be downloaded to the user's client device. The trial version is preferably fully featured or otherwise identical to the full version; however, the trial version can alternatively be a simplified, reduced-function, feature-limited, or otherwise altered version (e.g., a dramatization) of the full version.

The software application can relate to and/or provide a wide variety of functions and information, including, for example, entertainment (e.g., a game, music, images, videos, etc.), business (e.g., word processing, accounting, spreadsheets, etc.), news, weather, finance, sports, web browsing, etc. In preferred implementations, the software application can provide an online game, such as, for example, a massively multiplayer online (MMO) game or the like.

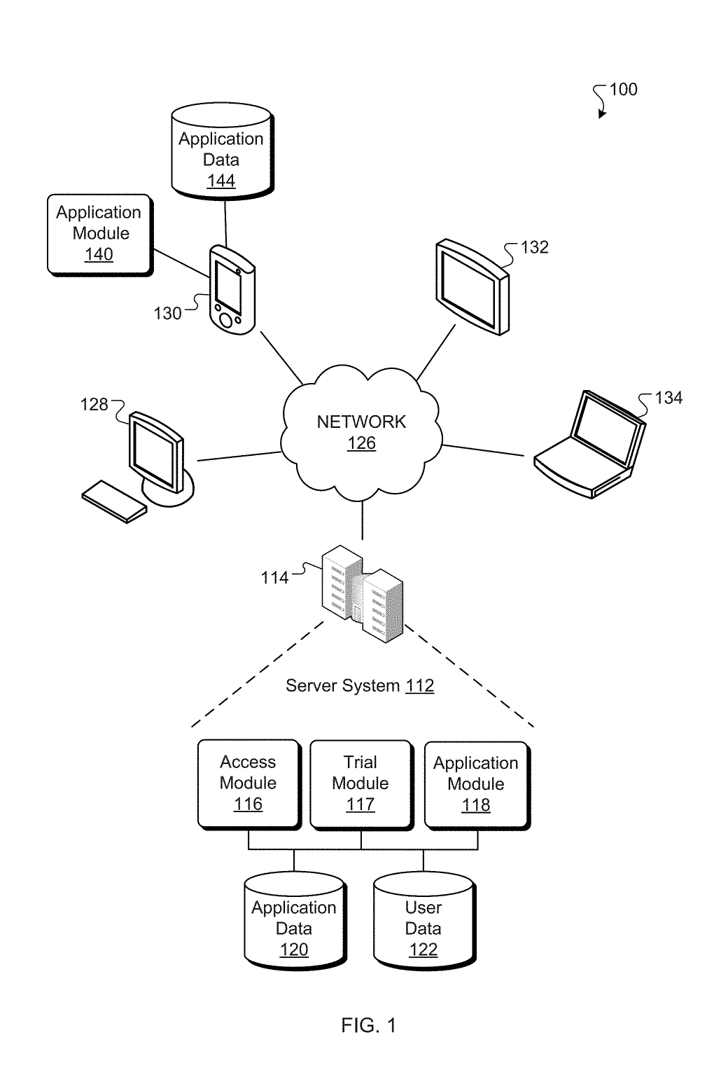

FIG. 1 illustrates an example system 100 for providing trial versions and full versions of software applications (e.g., for online games) on user client devices. A server system 112 provides functionality for providing access to the trial versions and the full versions, and for allowing users of client devices to try the trial versions prior to installing the full versions. The server system 112 includes software components and databases that can be deployed at one or more data centers 114 in one or more geographic locations, for example. The server system 112 software components can include an access module 116, a trial module 117, and an application module 118. The software components can include subcomponents that can execute on the same or on different individual data processing apparatus. The server system 112 databases can include an application data 120 database and a user data 122 database. The databases can reside in one or more physical storage systems. The software components and data will be further described below.

In preferred examples, users can interact with the server system 112 by accessing the trial versions, the full versions, and/or a website or similar service that provides users with access to the trial versions and the full versions. A network 126 (e.g., the Internet) can connect the server system to user client devices, such as a personal computer 128, a smart phone 130, a tablet computer 132, and a laptop computer 134. Other client devices are possible.

FIG. 1 depicts the access module 116, the trial module 117, and the application module 118 as being able to communicate with the server system 112 databases (e.g., the application data 120 and the user data 122 databases). The application data 120 database generally includes information related to the trial versions and the full versions of software applications. Such information can include, for example, graphical user interface data, algorithm data, image data, video data, text data, and other forms of data required to provide functioning trial versions and full versions for users of the client devices 128, 130, 132, and 134. The user data 122 database generally includes information related to user interactions with the trial versions, the full versions, the client devices 128, 130, 132, and 134, and/or the server system 112. Such information can be or include, for example, a history of user inputs to the trial versions and the full versions, a history of connections to and/or interactions with the system 100, a history of content presented to users, user purchases, user assets, user accomplishments, user tasks, and/or user interactions with other users (e.g., group chats). While FIG. 1 depicts the access module 116, the trial module 117, and the application module 118 as being part of the server system 112, it is understood that the access module 116, the trial module 117, the application model 118, or any portions thereof can reside on or be implemented by the client devices 128, 130, 132, and 134.

Likewise, each client device in the system 100 can utilize or include software components and databases for providing the trial versions and/or the full versions of software applications. The software components on the client devices can include an application module 140, which can implement the trial versions and/or the full versions on each client device, as described herein. The databases on the client devices can include an application data 144 database which can store information for the trial versions and/or the full versions and exchange the information with the application module 140. The data stored on the application data 144 database can include, for example, image data, video data, algorithm data, user data, and any other data or content used or generated by the application module 140, the access module 116, the trial module 117, and/or the application module 118. While the application module 140 and the application data 144 database are depicted as being associated with the smart phone 130, it is understood that other client devices (e.g., the personal computer 128, the tablet computer 132, and/or the laptop computer 134) can include the application module 140 and the application data 144 database, and any portions thereof.

In various examples, the access module 116, the trial module 117, the application module 118, and the application module 140 are configured to provide the trial versions and full versions of software applications on user client devices. The access module 116, for example, can be, include, or provide a website, application, or similar service that provides users with access to the trial versions and the full versions. In some examples, the access module 116 provides an app marketplace or app store in which software applications are available for trial and/or download. The trial module 117 can include or implement the trial versions, which preferably run on the server system 112 (e.g., as server applications) rather than on client devices. In such instances, users can access the trial versions without having to download the trial versions or any portions thereof on the user client devices. The application module 118 and the application module 140 can provide full versions of software applications to users. In a typical example, the full versions can be obtained by downloading and installing the full versions on the user client devices. The application module 140 can be or include the full version of a software application installed on a user client device (e.g., a client application). The application module 118 can be or include a software component that provides support for the full version. For example, the full version of a software application running on a client device (e.g., using the application module 140) can interact with the application module 118 running on the server system 112, which can provide updates, coordinate activity among multiple users, or support other features for the full version.

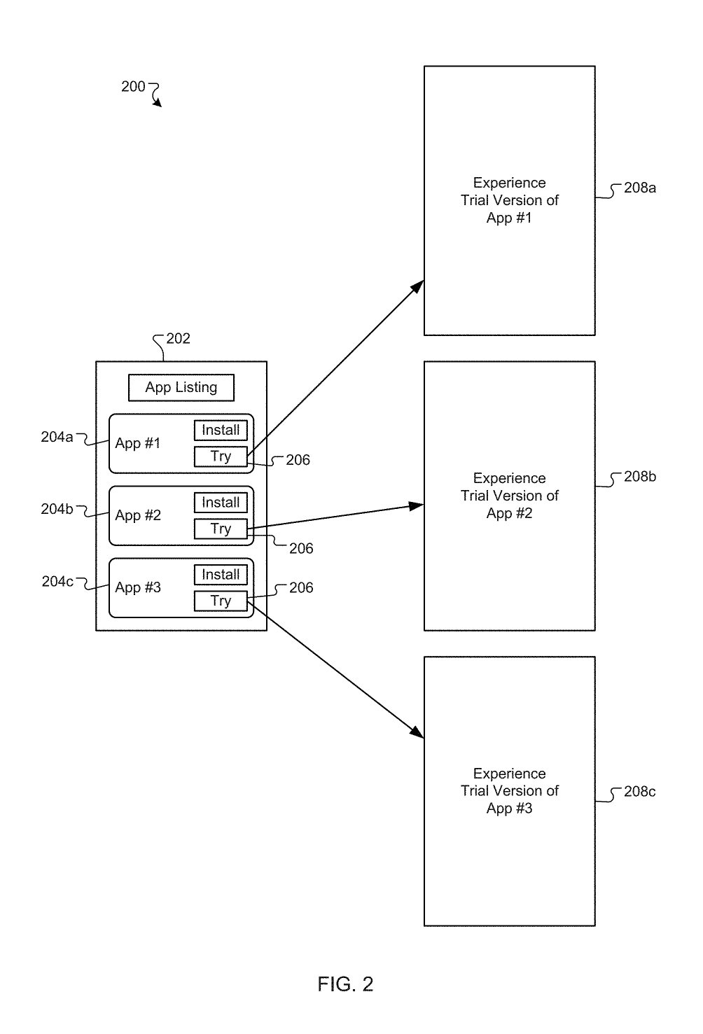

Referring to FIG. 2, an example method 200 is provided in which a website and/or similar application or service (e.g., an app marketplace or app store, such as iTUNES APP STORE or GOOGLE PLAY) allow users to access trial versions of software applications. A graphical user interface 202 for the website can be provided that presents available trial versions and includes buttons or links that users can select to activate the trial versions. In the specific example, the graphical user interface 202 includes icons 204a-c representing three different software applications. Within or near each icon is a try button 206 that a user can select to launch a trial version 208a-c for the corresponding software application. When the try button 206 for one of the software applications is selected, the user can experience the corresponding trial version 208a-c. The website and the graphical user interface 202 can be created and/or operated using the access module 116.

In preferred implementations, the trial version for each software application can be implemented by the trial module 117 and run on the server system 112, without requiring the trial version or any portion thereof to be downloaded onto user client devices. For example, when a user selects the try button 206 on a user client device, the trial module 117 can initiate execution of the trial version of the software program on the server system 112 and enable the user to interact with the trial version on the client device. In some examples, the trial version can be supplied to the access module 116 and/or the trial module 117 by a software developer that created the trial version and corresponding full version.

In some examples, the server system 112 includes one or more server computers that can be operated by one or more different system components or entities. The components can include, for example, the access module 116, the trial module 117, the application module 118, a software developer, a software provider, or a similar component or entity. When a user selects the try button 206, for example, the trial version can be run on a server computer operated by any one or more of these entities. In one example, a server computer operated by an app marketplace or app store (e.g., as provided by the access module 116) can run the trial version. Additionally or alternatively, the trial version can be run on a server computer operated by a software developer, a software provider, or similar entity. In such a case, the trial version can be hosted on an app developer's server or on a third party server used by the app developer. When the user selects the try button, the access module 116 and/or the trial module 116 can call for or otherwise retrieve the trial version from the app developer's server or third party server. Additionally or alternatively, when the user selects the try button 206, the user can be redirected to a landing page or other website hosted by the app developer, a third party, or other component or entity. The user can select and/or interact with the trial version from the landing page.

In some examples, the trial version can be pre-cached by the access module 116 and/or the trial module 117, so that the trial version is ready to run once the user opts to experience the trial version. Pre-caching the trial version can be done in anticipation of the user selecting the trial version on the user's client device. In some instances, for example, pre-caching involves intelligent downloading of the trial version to a server computer when a user is browsing a listing of available trial versions. Alternatively or additionally, when a user searches for a software application, a trial version of the software application, or a trial version for each search result, can be pre-cached in anticipation of user selection. In various implementations, a trial version can be pre-cached when the option of running the trial version is being displayed or is close to being displayed on the client device. Pre-caching can include, for example, retrieving an executable file for the trial version (e.g., the trial module 117 or other server application), initiating the executable file, and/or retrieving any metadata required to provide an operable version of the trial version. In certain examples, the trial versions and/or the full versions of online games can be provided using HTML 5, javascript, and/or similar frameworks.

Additionally or alternatively, in certain implementations, the performance of trial versions can be improved by reducing display or graphical requirements for the trial versions. This can alleviate processing loads on the client devices and/or reduce potential bandwidth issues associated with sending information from the server system 112 to the client devices. The reduced display requirements can be achieved in any number of suitable ways. For example, the resolution of a trial version can be made lower (e.g., standard definition or 480p) than the resolution of a corresponding full version (e.g., high definition or 1080p). Additionally or alternatively, highly complex graphical elements or objects that may be present in the full version can be removed from the trial version or replaced with less complex graphical elements or objects. Other ways of reducing the graphical complexity and/or graphical processing requirements of the trial versions are possible. In some instances, the graphical requirements for a trial version can depend on the display capabilities of the client device. The server can be configured to provide, for example, higher quality trial versions to more capable client devices and lower quality trial versions to less capable client devices. In general, by reducing the display requirements, the trial versions can be displayed on client devices more efficiently, particularly on older client devices, which can have outdated graphics capabilities.

In certain instances, the storage and/or processing capabilities of the server system 112 are configured to run thousands or even millions of trial versions concurrently. The trial versions and/or full versions are preferably stored remotely on the server system 112 or in an associated database (e.g., the application data 120 database). In preferred implementations, the server system 112 is configured to have adequate computer storage for retaining and providing the trial version and/or full version of each online game. The server system 112 is preferably also configured to have sufficient processing capabilities, such that thousands or millions of trial versions can be run on the server system 112 concurrently, according to user demand.

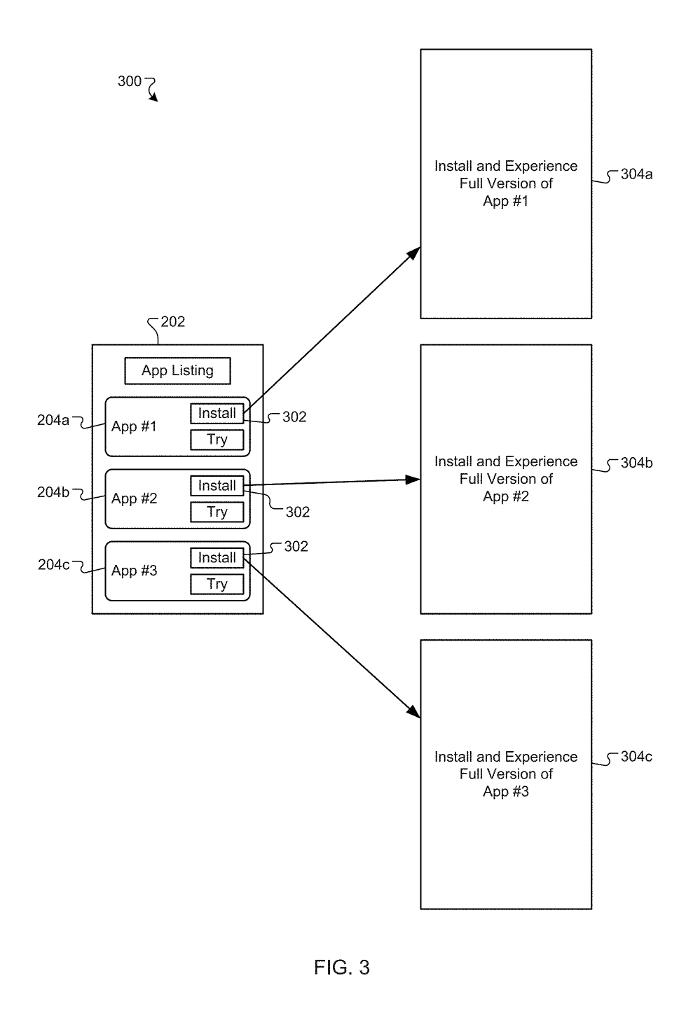

Referring to FIG. 3, an example method 300 is provided in which the website and/or similar application or service (e.g., the app marketplace or app store) allows users to access full versions of software applications (e.g., using the application module 140). The graphical user interface 202 can present the available full versions and can include buttons or links that users can select to download and/or activate the full versions. In the depicted example, the graphical user interface 202 includes the icons 204a-c for three different software applications. Within or near each icon is an install button 302 that a user can select to download and install a full version 304a-c of the corresponding software application. When a user selects the install button 302 for one of the icons 204a-c, the full version 304a-c of the corresponding software application can be downloaded and installed on the user client device. Once installed, the user can experience the full version 304a-c of the software application. In a typical example, the user selects the install button 302 once the user has tried the trial version and decides to proceed with the full version.

In some implementations, when a user searches an app marketplace or similar website for, for example, “football games,” the user can be presented with a large number of potentially relevant football game apps to choose from, as well as a way to view standalone landing pages that give additional information describing each app. The landing pages may have static images, descriptions, or even videos that the user can review to obtain information about the app. According to the systems and methods described herein, however, the user can experience real gameplay for each app without having to first download the app. Consequently, if the user wants to test multiple games to see which one the user enjoys playing the most, the user can select the try button 206 to experience the trial version for any apps of interest. If the user wants to try three different football games, for example, the user can select the try button 206 and experience the trial version for each game, before downloading or installing any of the three games. Not all apps are free, and the systems and methods described herein can allow users to try apps before purchasing.

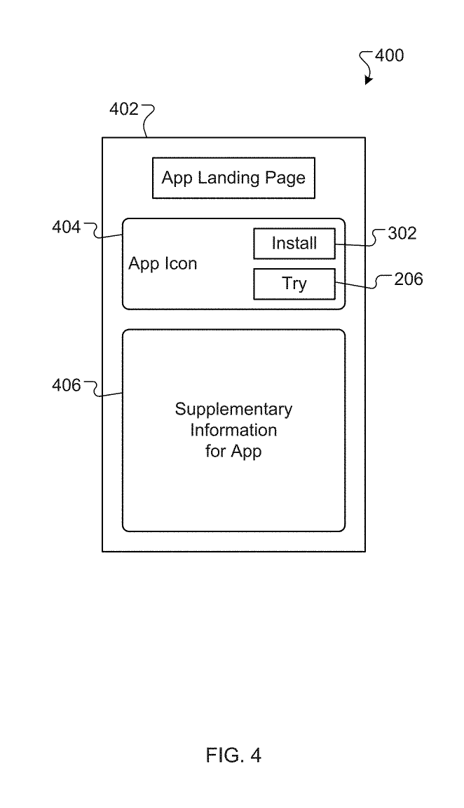

Additionally or alternatively, a user can access trial versions of software applications in an app marketplace in various ways. Still referring to FIG. 3, for example, the graphical user interface 202 can be presented in response to a user searching for specific apps (e.g., football games) and/or can provide a listing of recommended or featured apps. Additionally or alternatively, trial versions can be accessed from a standalone landing page for a specific app. Referring to FIG. 4, for example, when a user searches for or selects a specific app, a landing page 400 for the app can be presented in a graphical user interface 402. The landing page 400 can include the try button 206 and the install button 302, which the user can select to run the trial version and install the full version, respectively. The landing page can also include an app icon 404 and/or supplementary information 406 related to the app, such as static images, screenshots, descriptions, videos, and/or user reviews.

In some examples, user access to trial versions can be limited according to an amount of time or an amount of content a user can consume in the trial versions, before the user is required to download the full version to further experience the software application. For instance, an app developer or an app marketplace (e.g., as controlled by the access module 116 or the trial module 117) can limit a user to 30 seconds, 2 minutes, or 10 minutes (or other suitable time period) of access to a trial version before the user is prompted to either download the full version or end engagement with the trial version. Alternatively, the app developer or app marketplace (e.g., as controlled by the access module 116 or the trial module 117) can limit a user to a certain level, milestone, or achievement (e.g., reaching a particular level of a trial version of an adventure or strategy game, scoring or obtaining a certain number of points in a trial version of a sports game, etc.) before the user is prompted to either download the full version or end engagement with the trial version. In alternative examples, users can be granted unlimited time and/or access to engage with the trial version, particularly when the trial version does not include certain features present in the full version.

Additionally or alternatively, the access module 116 and/or the trial module 117 can set appropriate logic that automatically downloads the full version when the user engages with the trial version beyond a certain point. For example, when a user engages with the trial version for more than 5 or 10 minutes (or other suitable time period) or reaches a certain level or milestone within the trial version, the full version can be automatically downloaded in the background. If the user subsequently attempts to begin a second session with the trial version, the full version can be opened and run on the user client device instead.

In certain examples, any progress made by a user in a trial version can be saved and accessed later from the full version. When a user engages with the trial version before installing the full version, for example, the user's progress from the trial version can be recognized when the full version is opened. If a user reaches a certain level in the trial version of a game (e.g., level 10 or other appropriate level or milestone), the user can be started at that level upon opening the downloaded full version, rather than having to restart the game at level 1. Similarly, any in-game rewards or items received by the user while engaging with the trial version can be transferred over to the user upon opening the full version. In a typical example, the trial module 117 can save progress for the trial version to the user data 122 database, which can provide the progress data to the application module 140 and/or the application module 118 when the user runs the full version.

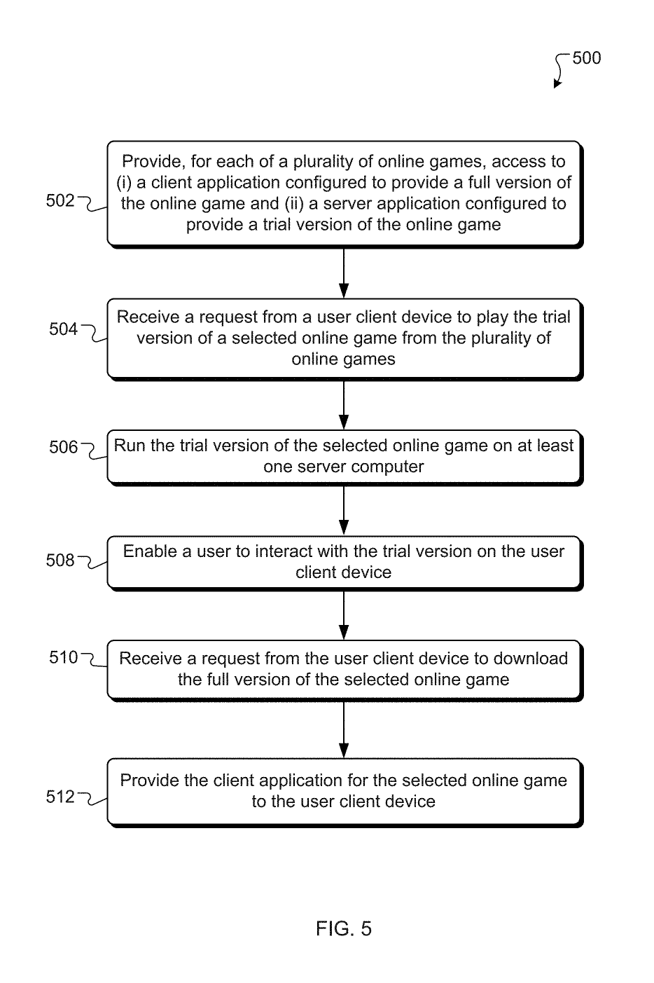

FIG. 5 illustrates an example computer-implemented method 500 of providing trial versions and full versions of software applications on user client devices. For each of a plurality of online games, access is provided (step 502) to (i) a client application (e.g., the application module 140) configured to provide a full version of the online game and (ii) a server application (e.g., the trial module 117) configured to provide a trial version of the online game. A request is received (step 504) from a user client device (e.g., when the user selects the try button 206) to play the trial version of a selected online game from the plurality of online games. In response to the request: the trial version of the selected online game is run (step 506) on at least one server computer; a user is allowed or enabled (step 508) to interact with the trial version on the user client device; a request is received (step 510) from the user client device (e.g., when the user selects the install button 302) to download the full version of the selected online game; and the client application for the selected online game is provided (step 512) to the user client device for installation. Once installed, the user can access the full version by running the client application on the client device.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., offer hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A method, comprising:
providing, for each of a plurality of online games, access to (i) a client application configured to provide a full version of the online game and (ii) a server application configured to provide a trial version of the online game;
receiving a request from a user client device to play the trial version of a selected online game from the plurality of online games and, in response thereto:
running the trial version of the selected online game on at least one server computer;
enabling a user to interact with the trial version on the user client device;
receiving a request from the user client device to download the full version of the selected online game; and
providing the client application for the selected online game to the user client device.

2. The method of claim 1, wherein providing access to the client application and the server application comprises:
providing a graphical user interface comprising an icon for each of the plurality of online games, wherein the icon comprises a first button corresponding to the full version and a second button corresponding to the trial version.

3. The method of claim 1, wherein, for each of the plurality of online games, (i) the client application is configured to be run on user client devices and (ii) the server application is configured to be run on the at least one server computer.

4. The method of claim 1, wherein the trial version of the selected online game is lacking one or more game features present in the full version of the selected online game.

5. The method of claim 1, wherein, for each of the plurality of online games, the trial version comprises a time-limited version of the full version.

6. The method of claim 1, wherein running the trial version on the at least one server comprises:
not running the trial version on the user client device.

7. The method of claim 1, wherein enabling the user to interact with the trial version comprises:
saving progress of the user in the trial version of the selected online game.

8. The method of claim 7, wherein providing the client application for the selected online game comprises:
providing the user with access to the saved progress from the trial version of the selected online game.

9. The method of claim 1, wherein providing the client application for the selected online game comprises:
providing a downloadable copy of the client application to the user client device.

10. The method of claim 9, wherein providing the client application for the selected online game comprises:
running an installation of the downloadable copy on the user client device.

11. A system, comprising:
one or more computer processors programmed to perform operations comprising:
providing, for each of a plurality of online games, access to (i) a client application configured to provide a full version of the online game and (ii) a server application configured to provide a trial version of the online game;
receiving a request from a user client device to play the trial version of a selected online game from the plurality of online games and, in response thereto:
running the trial version of the selected online game on at least one server computer;
enabling a user to interact with the trial version on the user client device;
receiving a request from the user client device to download the full version of the selected online game; and
providing the client application for the selected online game to the user client device.

12. The system of claim 11, wherein providing access to the client application and the server application comprises:
providing a graphical user interface comprising an icon for each of the plurality of online games, wherein the icon comprises a first button corresponding to the full version and a second button corresponding to the trial version.

13. The system of claim 11, wherein, for each of the plurality of online games, (i) the client application is configured to be run on user client devices and (ii) the server application is configured to be run on the at least one server computer.

14. The system of claim 11, wherein the trial version of the selected online game is lacking one or more game features present in the full version of the selected online game.

15. The system of claim 11, wherein, for each of the plurality of online games, the trial version comprises a time-limited version of the full version.

16. The system of claim 11, wherein running the trial version on the at least one server comprises:
not running the trial version on the user client device.

17. The system of claim 11, wherein enabling the user to interact with the trial version comprises:
saving progress of the user in the trial version of the selected online game.

18. The system of claim 17, wherein providing the client application for the selected online game comprises:
providing the user with access to the saved progress from the trial version of the selected online game.

19. The system of claim 11, wherein providing the client application for the selected online game comprises:
providing a downloadable copy of the client application to the user client device.

20. An article, comprising:
a non-transitory computer-readable medium having instructions stored thereon that, when executed by one or more computer processors, cause the computer processors to perform operations comprising:
providing, for each of a plurality of online games, access to (i) a client application configured to provide a full version of the online game and (ii) a server application configured to provide a trial version of the online game;
receiving a request from a user client device to play the trial version of a selected online game from the plurality of online games and, in response thereto:
running the trial version of the selected online game on at least one server computer;
enabling a user to interact with the trial version on the user client device;
receiving a request from the user client device to download the full version of the selected online game; and
providing the client application for the selected online game to the user client device.
